(19) United States
(12) Patent Application Publication
(10) Pub. No.: US 2007/0062079 A1
(43) Pub. Date: Mar. 22, 2007

(54) Self-Supporting Display Devices and Methods for Forming Them

(75) Inventor: Martha Mahon, St. Louis, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Martha Mahon

(21) Appl. No.: 11/534,057

(22) Filed: Sep. 21, 2006

Related U.S. Application Data
(60) Provisional application No. 60/719,243, filed on Sep. 21, 2005.

(51) Int. Cl. G09F 1/00

(52) U.S. Cl. 40/124.01

(57) ABSTRACT

A self-supporting display device having a three-dimensional shape when in an assembled state. The device includes a single sheet including a core having a first end and a second end opposite the first end and a surrounding material around the core. The device further includes separation outlines separating the core from the surrounding material, thereby forming a periphery of the core when the sheet is separated along them during assembling of the device. The core includes a primary face having a display portion and a first tab adjacent the first end of the core that supports the device when it is in the assembled state. The core further includes interior separation lines forming a cutout portion when the device is in an unassembled state and fold lines for folding along to form a three-dimensional shape during assembling of the device.

### CROSS REFERENCE TO RELATED APPLICATION

This application claims priority from U.S. Provisional Application Ser. No. 60/719,243 filed on Sep. 21, 2005, which is incorporated herein by reference in its entirety.

### BACKGROUND OF THE INVENTION

The present invention relates to self-supporting display devices, and specifically to self-supporting display devices for displaying art, photos, and the like.

Conventional display devices such as picture frames generally include multiple pieces and materials and are relatively plain in appearance. Multi-piece display devices are generally relatively expensive to manufacture and/or difficult to assemble. For example, a picture frame comprising a frame and a separate support requires separate processes to make each component. Further, the components must be adapted to connect to one another directly or by way of fasteners.

It is also generally more costly to make display devices from multiple materials. For example, it is relatively expensive to make a display device including a plastic or metal frame, a cardboard backing, a glass face plate, and a plastic or metal stand attached to the frame or backing.

Moreover, many display devices are relatively plain in appearance. For example, many display devices include a generally square or rectangle shape and having no colors or designs beyond those inherent to the materials forming them. There is a need for relatively low cost, structurally reliable, and aesthetically pleasing display devices.

### BRIEF SUMMARY OF THE INVENTION

The present invention relates to a self-supporting display device having a three-dimensional shape when in an assembled state. The device includes a single sheet including a core having a first end and a second end opposite the first end and a surrounding material around the core. The device further includes separation outlines separating the core from the surrounding material, thereby forming a periphery of the core when the sheet is separated along them during assembling of the device. The core includes a primary face having a display portion and a first tab adjacent the first end of the core that supports the device when it is in the assembled state. The core further includes interior separation lines forming a cutout portion when the device is in an unassembled state and fold lines for folding along to form a three-dimensional shape during assembling of the device.

In another aspect, the present invention relates to a self-supporting display device having a three-dimensional shape when in an assembled state. The device comprises a core having a first end and a second end opposite the first end and a periphery surrounding the core. The core includes a primary face having a display portion and a first tab adjacent the first end of the core that supports the device when it is in the assembled state. The core further includes interior separation lines forming a cutout portion when the device is in an unassembled state and fold lines for folding along to form a three-dimensional shape during assembling of the device.

In yet another aspect, the present invention relates to a method of creating a three-dimensional self-supporting display device including providing a generally rectangular blank having separation lines indicating where the blank is to be separated along and at least three fold lines indicating where the blank is to be folded. The method further includes separating adjacent portions of the blank separated by the separation lines from each other thereby forming a core including a tab for supporting the device. The method also includes folding the blank along the fold lines to form the three-dimensional display device, which can support itself in an upright position at least in part using the tab.

Other aspects of the present invention will be in part apparent and in part pointed out hereinafter.

### BRIEF DESCRIPTION OF THE DRAWINGS

FIG. 1 is a plan of a first embodiment of a display device according to the present invention shown in an unassembled state.

FIG. 2 is a perspective of the first embodiment shown in an assembled state.

FIG. 3 is a plan of a second embodiment of a display device according to the present invention shown in an unassembled state.

FIG. 4 is a plan of a third embodiment of a display device according to the present invention shown in an unassembled state.

FIG. 5 is a plan of a fourth embodiment of a display device according to the present invention shown in an unassembled state.

FIG. 6 is a plan of a fifth embodiment of a display device according to the present invention shown in an unassembled state.

FIG. 7 is a plan of a sixth embodiment of a display device according to the present invention shown in an unassembled state.

FIG. 8 is a perspective of the sixth embodiment shown in an assembled state.

FIG. 9 is a plan of a seventh embodiment of a display device according to the present invention shown in an unassembled state.

FIG. 10 is a plan of an eighth embodiment of a display device according to the present invention shown in an unassembled state.

FIG. 11 is a plan of a ninth embodiment of a display device according to the present invention shown in an unassembled state.

Corresponding reference characters indicate corresponding parts throughout the several views of the drawings.

### DETAILED DESCRIPTION OF THE INVENTION

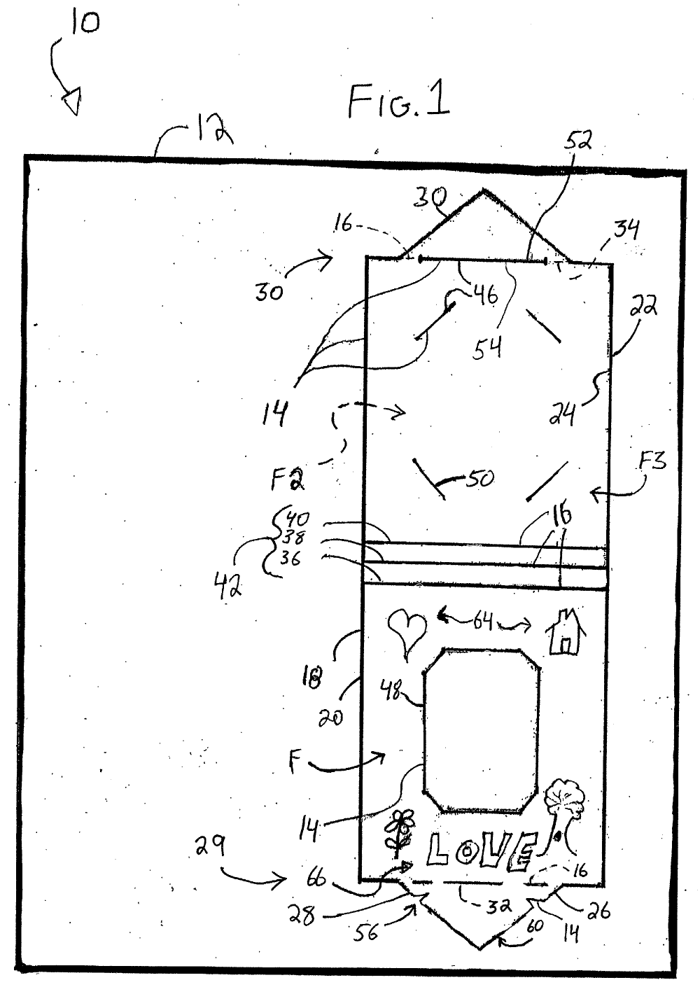

Referring now to the figures, and more particularly to FIG. 1, a device according to a first embodiment of the present invention is designated in its entirety by reference number 10. The display device 10 is shown in its initial or unassembled state in FIG. 1, in which the device includes an entire sheet or blank 12. The blank 12 may be made of various materials without departing from the scope of the present invention. For example, the blank 12 may be made of paper or card stock. In one embodiment, the paper has a weight between about 130 g/m² (grams per square meter) and about 230 g/m². Other embodiments have weights above and below this exemplary range. Although the blank 12 may have various shapes and sizes without departing from the scope of the present invention, in one embodiment, the blank is generally rectangular and measures about 11 inches long and about 8.5 inches wide (an “8½×11” sheet of paper). Other blank 12 sizes, such as those corresponding with other standard sizes of paper (e.g., A4, legal, etc.), may be used instead of 8½×11. A benefit of having the blank made of an 8½×11 sheet, or other standard size, is that there are many existing manufacturing processes, packaging processes, and distribution channels designed to accommodate those sizes.

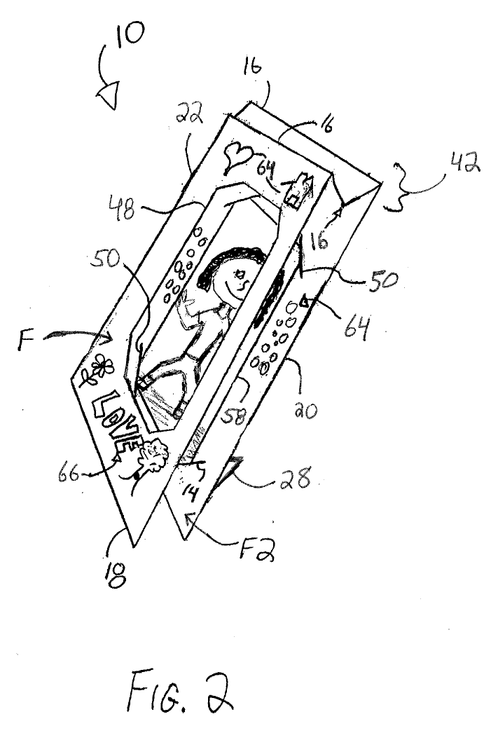

The blank 12 includes separation lines 14 and fold lines 16. The lines 14, 16 may be formed in various ways without departing from the scope of the present invention. For example, the lines 14, 16 may be formed by indentations, part way through the blank or intermittently (i.e., at spaced locations) all the way through the blank to form perforations. In this way, the blanks 12 may be “punch-outs” and the material of the blank may easily be separated along the separation lines 14 by hand. Instead of indentations, or along therewith, the lines 14, 16 may be marked, such as by ink. The separation lines 14 include outside lines or outlines 18 defining a periphery 20 of the device 10 when the device is in the assembled state (as shown in FIG. 2). Within the periphery 20 is a core 22 of the device. The outlines 18 separate the core 22 from the surrounding material 24 of the device.

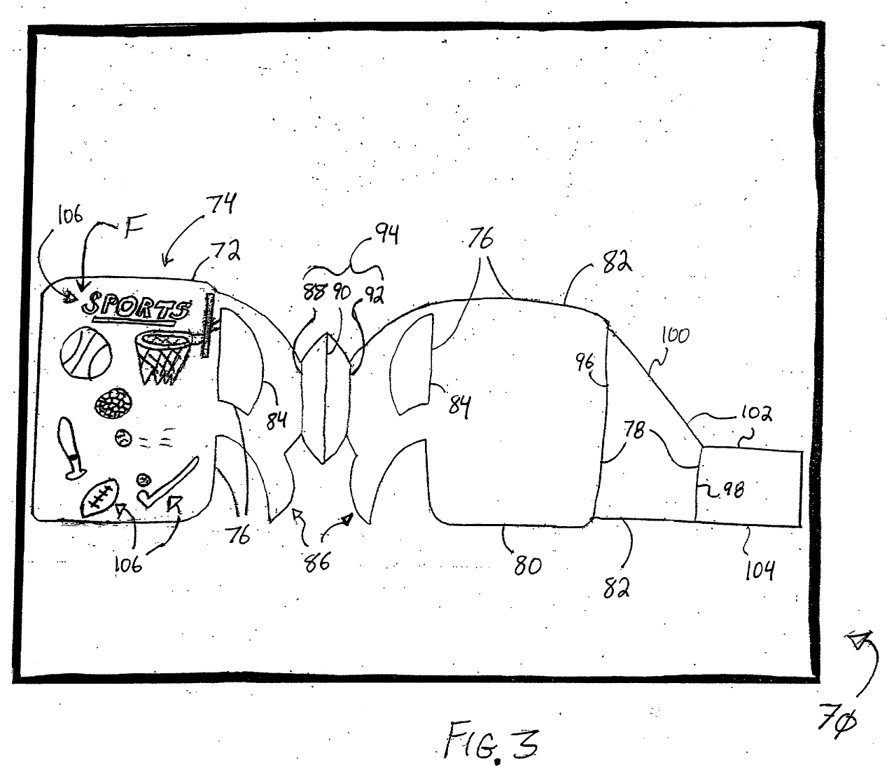

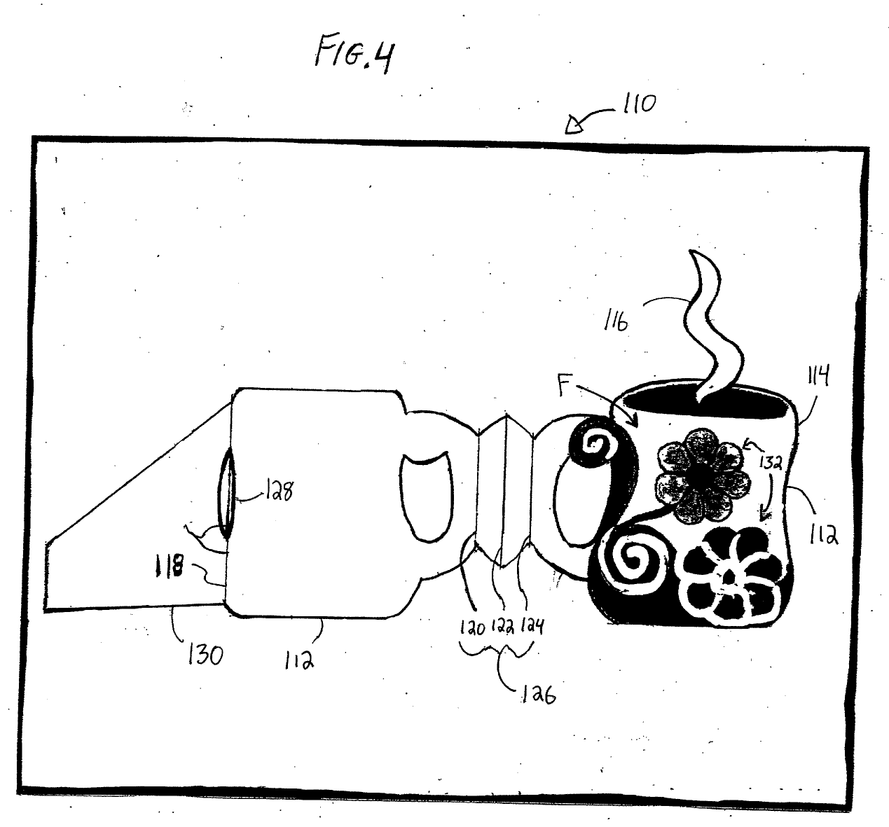

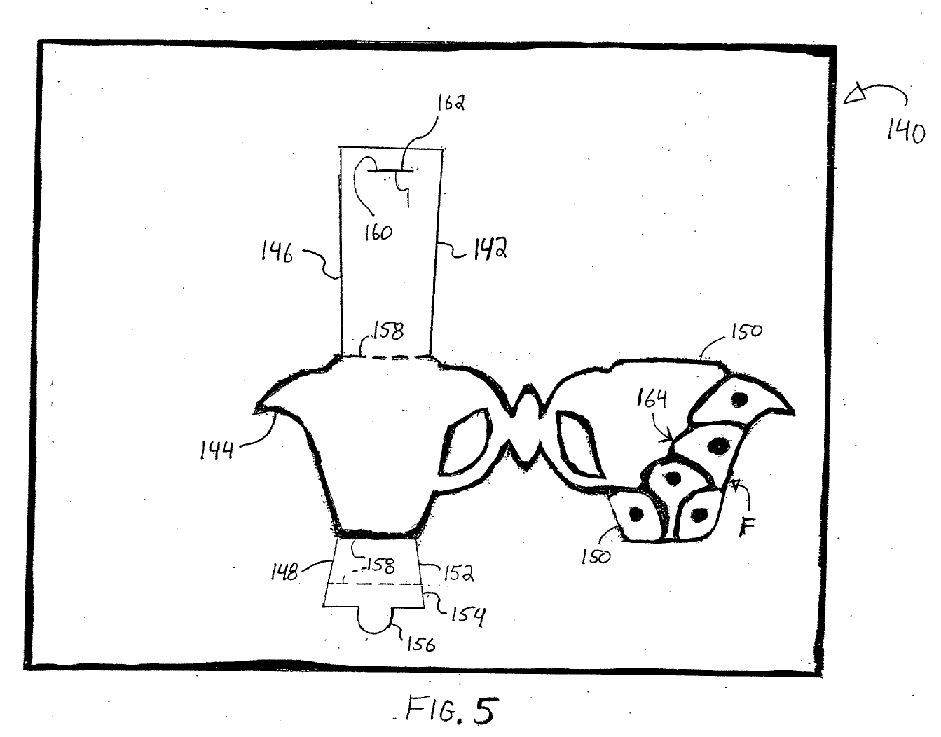

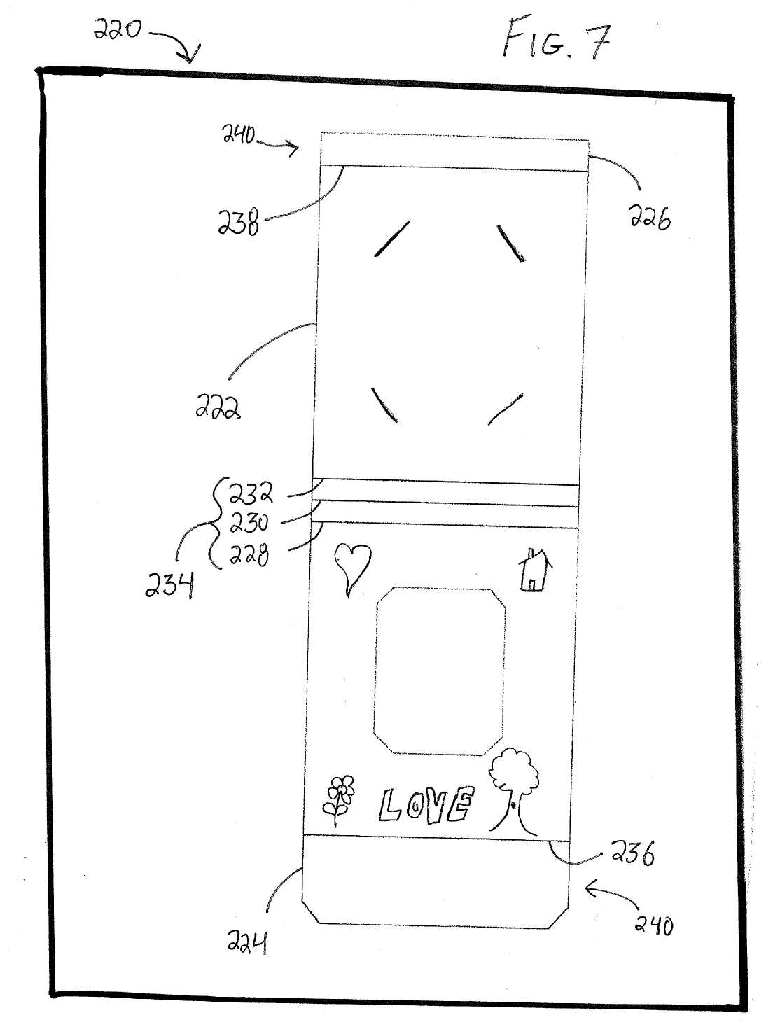

The periphery 20 may be shaped in innumerable ways without departing from the scope of the present invention. For example, the periphery 20 may be shaped so a primary face portion F of the core 22 is rectangular (as shown in FIGS. 1 and 7), square, oval, etc., or shaped like a common item such as a mug 74 (as shown in FIG. 3), a mug 114 having steam 116 extending upward from the mug (as shown in FIG. 4), or a cream pitcher 144 (as shown in FIG. 5). Other example primary face F shapes (not shown) include but are not limited to a tree, a wine glass or other cups or glasses, flowers, a house, a heart shape (e.g., a cardiod), an animal, a person, an insect, an automobile, a motorcycle, a boat, an airplane, a football, a golf bag, a bell, and a star.

The outlines 18 may also form tabs 26, which are areas of the device 10 where the periphery 20 protrudes for aesthetic and/or structural purposes. For example, the device 10 shown in FIG. 1 includes two tabs 26, a first tab 28 positioned adjacent a first end 29 of the core 22 and a second tab 30 positioned adjacent a second end 31 of the core. In this embodiment, a fold line 16 is positioned between the second tab 30 and the rest of the core 22 and a fold line and a separation line 14 are positioned between the first tab 28 and the balance of the core. The core 22 of the device 10 may have various sizes (e.g., maximum width and maximum height) without departing from the scope of the present invention. Specifically, the core 22 may have any size allowed by bounds of the sheet 12 on which the core is formed. For example, a core 22 formed on an 8½×11 sheet of paper may have a maximum height of between about 4 inches and about 11 inches and a maximum width of between about 2 inches and about 8½ inches.

Various fold lines 16 are arranged on the device 10 for various purposes. For example, the fold lines of the device 10 shown in FIGS. 1 and 2 include end fold lines 32, 34 and central fold lines 36, 38, 40. The core 22 is bent or folded about the end fold lines 32, 34 during assembling of the device 10 so the tabs 28, 30 are angled with respect to the rest of the core. The core 22 is bent or folded about the central fold lines 36, 38, 40 to form a pleat 42 allowing the device to double over itself, as shown in FIG. 2. The device 10 is self-supporting. That is, when the device 10 is in the assembled state, as shown in FIG. 2, the device can stand upright on a supporting surface (not shown), e.g., a table, without aid of another implement. For example, the assembled device 10 can stand on the surface without needing to lean against a wall.

Along with outlines 18, the separation lines 14 include inner or interior separation lines 44. The interior separation lines 44 may form lines for forming slits 46 and lines for forming openings or cutouts 48. In some embodiments, the device 10 is substantially free, within the core 22, of separation lines 14 for forming slits (see e.g., FIGS. 3 and 4). In the embodiment shown in FIG. 1, the slits 46 include item-holding slits 50 and structural slits 52 including a first or base structural slit 54 formed by a base separation line of the interior separation lines 44. The separation lines 14 may also include second or tab separation lines for forming tab slits 56. The item slits 50 are used to hold an item 58 to be displayed. For example, as an item 58, an appropriately sized picture may be mounted on the device 10 by inserting corners (not shown) of the picture into the item slits 50, as shown in FIG. 2. The first structural slit 54 is positioned adjacent the second tab 30 and receives part to all of the first tab 28 during assembly of the device 10. The second structural slits 56 are formed on a side edge 60 of the first tab 28 and receives a securing portion of the core 22 adjacent ends of the first structural slit 54 when the second tab is inserted into the first slit. As shown in FIG. 1, the second structural slits 56 may form generally v-shaped slots. When the second structural slits engage the core 22 as described, the second tab is secured in position with respect to the first tab. The second structural slits 56 are formed at a location on a side edge 60 of the second tab 30 so that the tabs 28, 30 and edges 62 of the core 22 adjacent the tabs form a base of desired dimensions allowing the assembled device 10 to stand stably on its own. It is envisioned that the device 10 may include only one second structural slit 56 positioned on the second tab 30 to securing the second tab to the first tab 28. The slits 14 may have various sizes without departing from the scope of the present invention. For example, in one embodiment, the item slits 50 has a length of about ¾ inch long, the first structural slit 54 has a length of about 1½ inches long, and each second structure slit 56 has a length of is about ¼ inch. In one embodiment, the item slits 50 are between about ½ inch and 1 inch long, the first structural slit 54 is between about 1¼ inches and about 1¾ inches long, and the second structure slits 56 are equal to or less than about ½ inch.

The primary face F may be positioned in front of a secondary face F2 (the back face F3 of which is shown in FIG. 1) when the device is assembled, as is the case with the embodiment of FIGS. 1 and 2. In this embodiment, the primary face F, with the material between the cutout 48 being removed, functions as a frame for the display item 58 (picture, art, or other) attached to or placed on the secondary face F2 for display. All surfaces of the device 10 may be decorated prior to, during, and/or after assembly as desired. In one embodiment, the blanks 12 are made at a manufacturing plant to have designs 64, as shown in FIGS. 1-6, which may include phrases, words or other indicia 66, as shown in FIGS. 1-3. All of the core 22 and designs 64 may be accented as desired. For example, the core and/or the designs 64 may be colored and/or textured. The blanks 12 could also include beginnings of a design formed on the core 22, such as guide lines, which may be used as a guide for end users to complete the design. For example, the core 22 may include guide lines forming the essence of a design and the user may color within the guide lines with colors of their choice or by colors designated by instructions to accentuate the design. Such instructions may be packaged and sold with the device 10.

For embodiments of the device 10 such as that shown in FIGS. 1 and 2, in which a front-side face F is folded over a back-side face F2, the designs 64 may be formed on the backside face F2 so that the designs can be viewed around and/or through the front-side face when the device is assembled. In these embodiments, designs 64 may also be formed on the face F3 opposite the back-side face F2 so observers of the device may view them when viewing the back of the assembled device.

In one embodiment, computer software allows a user to design their display device 10 as they please and print the design on blanks 12 using a standard printer. For example, a user may purchase a package of colored or uncolored 8½×11 blanks 12 having devices of the same or various shapes formed thereon as described above. The user may then access software (e.g., through a web site or via a compact disc (“cd”)) to select designs to print on the display devices. Exemplary designs the user may select include floral designs and sports-themed designs. After selecting designs, the user may insert the blank(s) 12 into a printer designed to accommodate the weight of paper being used and print the designs (colorful or not) onto the device 10. In another embodiment, a user accesses software (e.g., via internet or cd) that assists them in custom creating a core 22 and printing the custom core onto a blank piece of paper. For example, the software may guide a user to select a primary face F shape, choose designs 64, such as art and/or names or other words, and select colors to be added to the device, and print the device 10 including the designs 64 on a prepared sheet (e.g., pre-purchased from the manufacturer) having separation and fold lines already present. Alternatively, such a custom core 22 may be printed on a blank, non-prepared, standard sheet of paper, thereby forming the separation lines 14, fold lines 16, and designs 64. The devices 10 may be made and sold to users in a fully assembled state (e.g., the core 22 is designed, cut from the sheet 12, and folded) or at any of various intermediate stages of formation. For example, in one embodiment the device 10 is sold after it is cut out and colored but before it is folded along fold lines 16. In one embodiment, the device 10 is sold after it is cut out but before it is folded along fold lines 16 and before it is colored. In another embodiment, the device 10 is sold after it is colored but before it is folded.

FIG. 3 shows an embodiment of a device 70 according to the present invention in which the primary face F of a core 72 shaped as a mug 74. The device 70 includes separation lines 76 and fold lines 78. The separation lines 76 include outlines 80, forming a periphery 82 during assembly, and lines for forming cutouts 84 during assembly. In this embodiment, the device 70 may be formed without internal slits (similar to the internal slits 46 shown in FIG. 1). The outlines 80 and cutouts 84, which may include body cutouts to form corresponding holes as shown in FIG. 3, may be positioned to form handles 86 of the mug 74 when the device 70 is assembled. The fold lines 78 include primary fold lines 88, 90, 92, for forming a pleat 94 when the core 72 is folded in alternating directions along the primary fold lines during assembly of the device 70. The fold lines 78 also include tab fold lines 96, 98 for angling a first tab portion 100 of a tab 102 from the balance of the core 72 and a second tab portion 104 of the tab from the first tab portion. As will be appreciated by those skilled in the art, the core 72 is folded in the same or opposite direction/s with respect to the tab lines 96, 98 during assembly to form a stand. As with the other embodiments, this embodiment may include designs 106, such as art and/or words. The device 70 according to this embodiment is otherwise the same as that of the first embodiment and will therefore not be described in further detail.

FIG. 4 shows an embodiment of a device 110 according to the present invention, in which a core 112 has a primary face portion F shaped like a cup 114 holding a steaming beverage (note steam 116 shown). This embodiment includes only one tab fold line 118, but as with other embodiments, includes three central fold lines 120, 122, 124, for forming a pleat 126 when the core 112 is folded along them in opposite directions during assembly of the device 110. The device 110 may include a tab cutout 128 between the tab 130 and the balance of the core 112. As with the other embodiments, this embodiment may include designs 132. The device 110 according to this embodiment is otherwise the same as earlier described embodiments and therefore will not be described in further detail.

FIG. 5 shows an embodiment of a device 140 according to the present invention comprising a core 142 shaped as a cream pitcher 144 and including an upper tab 146 and a lower tab 148 formed by outlines 150. The lower tab 148 includes a first, a second, and a third tab portion 152, 154, 156. The first tab portion 152 is separated from the front face F and from the second tab portion 154 by respective fold lines 158. The upper tab 146 includes a separation line 160 in the form of a structural slit 162 for receiving the third tab portion 156 during assembly. As with the other embodiments, this embodiment may include designs 164. The device 140 is otherwise the same as previously described embodiments and therefore will not be described in further detail.

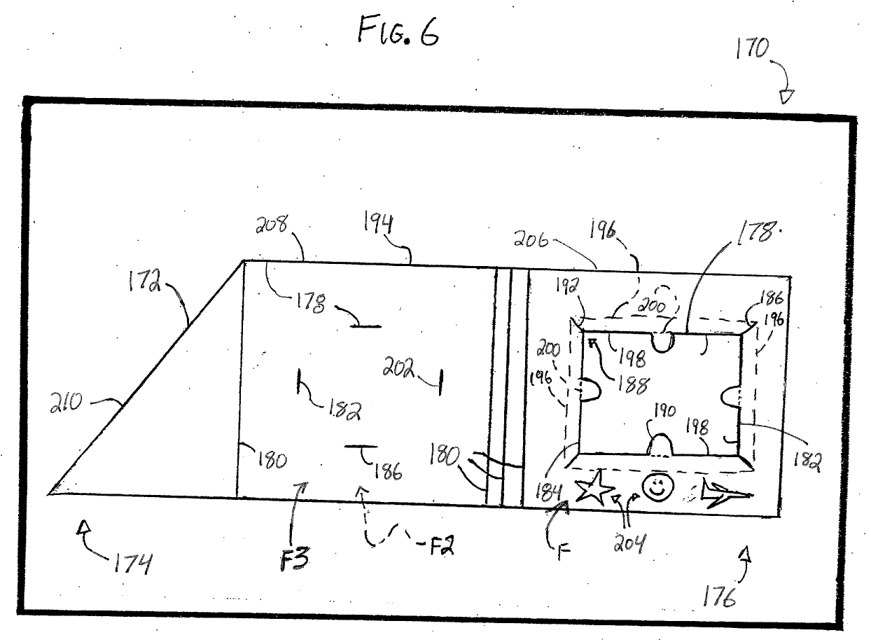

FIG. 6 shows an embodiment of a device 170 according to the present invention having a single tab 172 at a support end 174 of the device opposite a face end 176 of the device. The device 170 includes separation and fold lines 178, 180. The separation lines 178 include interior lines 182 forming a cutout 184 and slits 186. The cutout lines in this embodiment form a cutout 184 having corners 188 and multiple interior or inner tabs 190. Adjacent each corner 188 is a clearance slit 192 in the core 194 of the slits 186 allowing the core to be bent or folded about clearance fold lines 196 to form clearance flaps 198. The inner tabs 190 are bent with respect to the core 194, including possibly with respect to the clearance flaps (or the balance of the clearance flaps) 198, about inner tab fold lines 200. During assembly, the inner tabs 190 are inserted into corresponding insertion slits 202 of the slits 186 formed by the separation lines 178 from a backside of the upward-facing side in FIG. 6.

As with the other embodiments, this embodiment may include designs 204 formed on core 194. Specifically, in one embodiment the design is formed on at least the primary face F1 and the secondary face F2, which is opposite the secondary F3 shown facing upward in FIG. 6. The device 170 core 194 includes a first panel 206 comprising the tab 172, a second panel 208, and a third panel 210. The design on the secondary face F2 of the second panel 208 acts as the focal display of the display device 170, and may be, for example, a piece of art created by the user, added by the user to the device, inherent in the manufactured device, or added sometime post manufacture of the device. The design 204 formed on the secondary face F2 of the second panel 208 may be formed on a core (not shown) other than the device core 194 from the same or a separate sheet 12 and attached to the primary core to form or supplement the secondary face. Having a separate panel added, e.g., via adhesive, makes that portion of the device 170 thicker and thereby stronger. All sheets described may have any of various weights. Additional slits (not shown) may be added to hold an item such as a photo (not shown in FIG. 6) for being viewed through the cutout 184 when assembled, similar to the embodiment shown in FIGS. 1 and 2. The device 170 is otherwise identical to previous described embodiments and therefore will not be described in further detail.

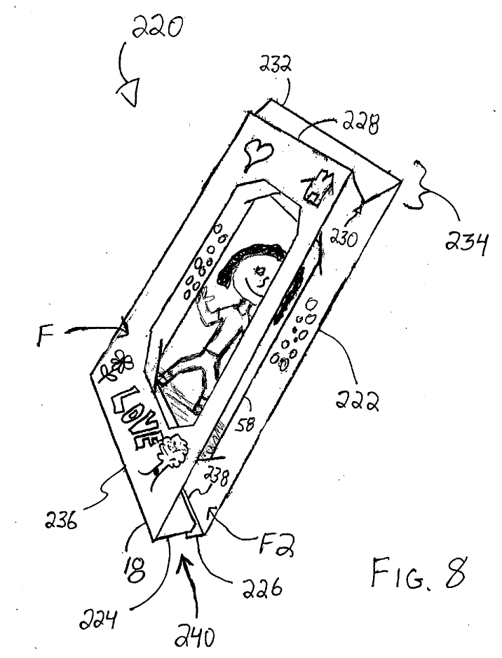

FIG. 7 shows an embodiment of a device 220 according to the present invention including a core 222. The device 220 of this embodiment is similar to the device 10 shown in FIGS. 1 and 2 except the device 220 of this embodiment includes first and second tabs 224, 226 having generally rectangular shapes. The device 220 further includes folding lines 228, 230, 232 and folding the core 222 about the fold lines forms a pleat 234 (shown in FIG. 8). The device 220 further includes tab folding lines 236, 238 about which the core 222 is bent so the tabs are angled with respect to primary and secondary faces F, F2 of the core. The tabs 224, 226 may be brought into contact with each other to form a base 240, as shown in FIG. 8, and the device 220 may stand on the base. Specifically, the first tab 224 of this embodiment may overlap the second tab 226 to form the base 240 and, as will be appreciated by those skilled in the art, friction between the first and second tabs 224, 226 when the device 220 is assembled works to keep the tabs together thereby fortifying the base. The device 220 can also stand when the pleat 234 and the tabs 222, 224 are formed so that the tabs do not contact each other (not shown). The device 220 of this embodiment is otherwise identical to earlier described embodiments and therefore will not be described in further detail.

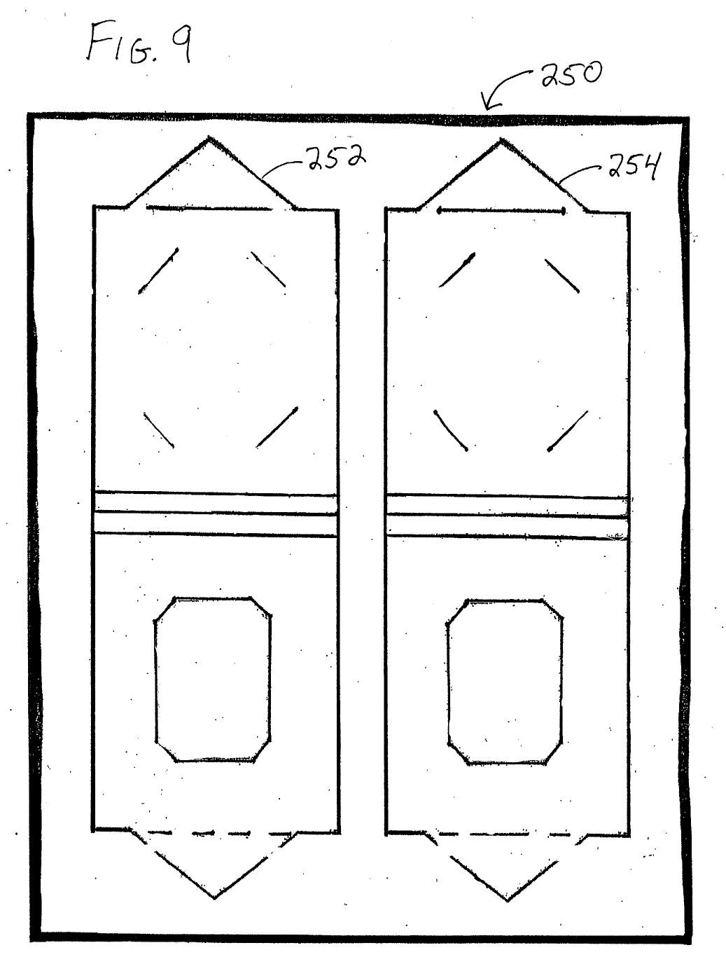

As shown in FIG. 9, a single sheet 250 of material may include multiple cores 252, 254. Each of the cores 252, 254 shown in FIG. 9 is similar to the core 22 shown in FIG. 1. Benefits of having multiple cores 252, 254 per sheet includes saving material and work associated with making the display devices, thus lowering the price per display device for the end user and helping the environment by using less resources. The devices according to this embodiment is otherwise the same as earlier described embodiments and therefore will not be described in further detail.

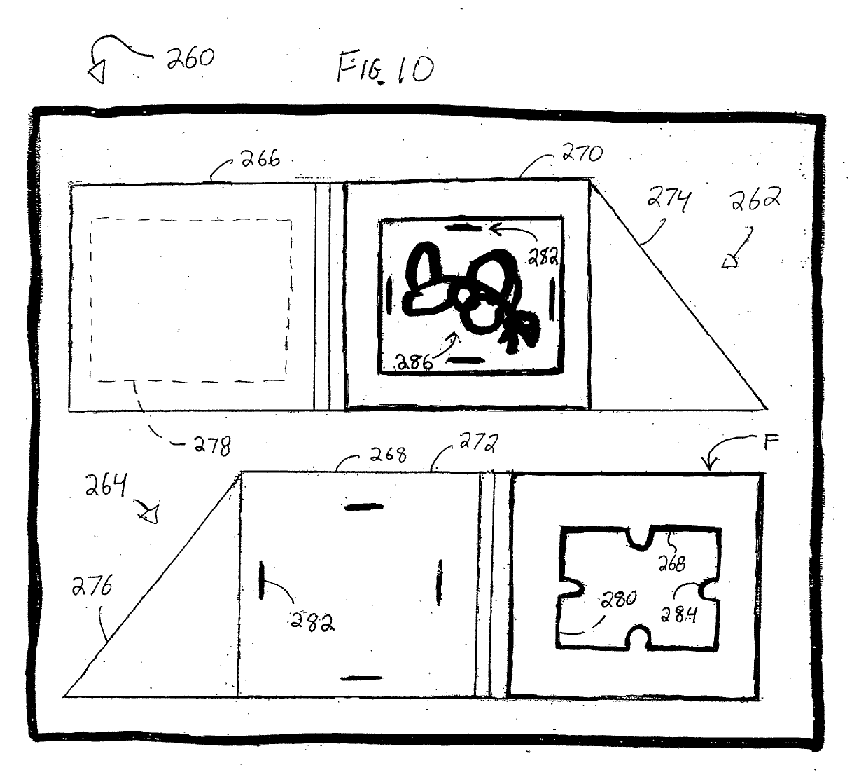

In the embodiments described above, the device may be unitary when the device is in the assembled state. That is, the device may be formed of totally or substantially one-piece, which is the core, when the device is assembled. The unitary device may include designs, decoration, and the like as describe above. In an embodiment shown in FIG. 10, a device 260 comprises multiple cores (e.g., two cores 262, 264) including respective separation lines 266, 268 including outlines 270, 272 forming peripheries 274, 276 when the device is assembled. In this embodiment, the cores 262, 264 may have the same periphery 274, 276 shape and may be used to form a single three-dimensional display device. In one embodiment (not shown), the outlines 266, 268 of the cores 262, 264 do not all have the same shape. The cores 262, 264 are overlaid during assembly to form an assembled three-dimensional display device resembling the shape of the assembled display device 170 of the embodiment shown in FIG. 6. For assembly, after the cores 262, 264 are separated from the rest of the sheet at the respective outlines 270, 272, the cores may be overlaid and attached to each other, such as by glue or other adhesive. As will be apparent to those skilled in the art, the cores 262, 264 may also be shaped (such as by having corresponding slits and tabs) to mechanically connect without adhesives. The second core 264 includes separation lines forming a cutout 278 corresponding to a cutout 280 formed along separation lines in the first core 262 and both cores include separation lines for forming slits 282 corresponding to inner tabs 284 formed by the cutout of the first core. In one embodiment (not shown), the cores 262, 264 do not include the inner tabs nor the corresponding slits 282.

When assembling the device 260 according to this embodiment, the cutouts 278, 280 are removed thereby forming the inner tabs 284, the slits 282 are formed, the cores 262, 264 are overlaid so that the cutouts are aligned, and the inner tabs 276 are inserted into the slits 282 of both cores. After the device 260 is assembled, designs 286 formed on the second core 264 are visible through the two cutouts 278, 280. Having two cores 262, 264 makes the assembled device thicker and thereby stronger. Also, having two cores 262, 264 allows the maker and/or user to accent (e.g., color, texture, and/or add designs 286 to) the cores on the same side of the sheet. As will be appreciated by those skilled in the art, overlaying the cores 262, 264 in various ways (e.g., so the cores are separated by various distances) creates various shapes for the assembled device thereby creating various visual effects. For example, when the cores 262, 264 are overlaid so they are slightly separated, the device presents a shadow-box effect whereby the frame portion around the cutout 278 of the first core is spaced from the surfacing on which the designs 286 are formed. That is, when the frame portion around the cutout of the first core 262 is spaced from the surface of the second core 264, light and shadows formed by the three-dimensional spacing creates the shadow-box effect. The devices of other embodiments including a frame portion around a cutout (e.g., the device 170 of FIG. 6) can also be assembled to create a shadow-box effect. Instead of overlaying an entire device, only a portion may be overlaid, as described above with respect to the device 170 shown in FIG. 6. The device 260 according to this embodiment is otherwise the same as earlier described embodiments and therefore will not be described in further detail.

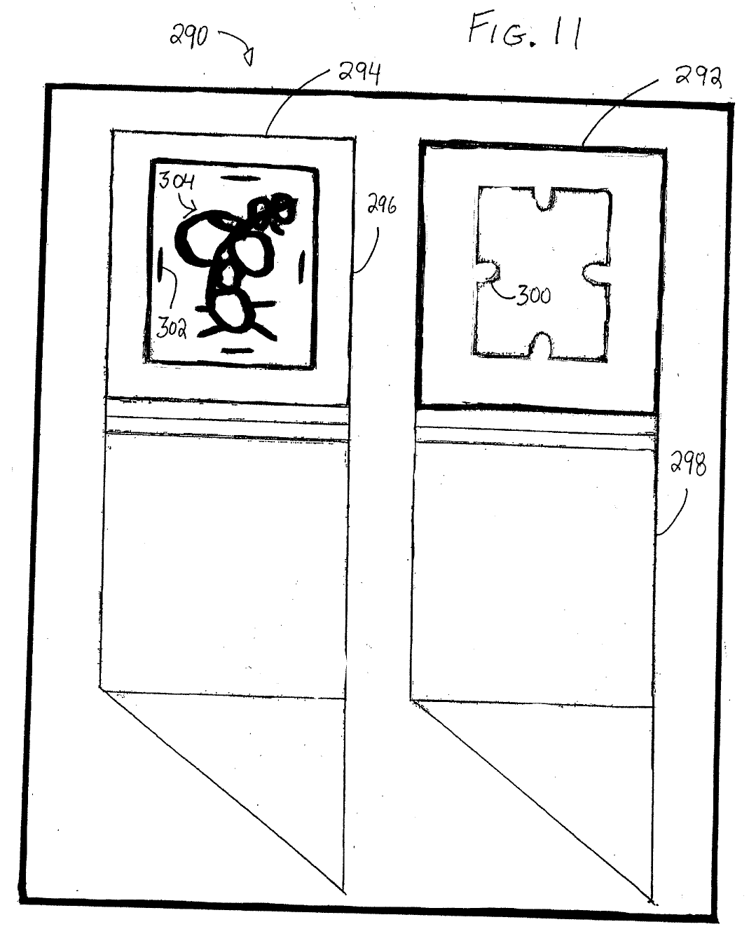

FIG. 11 shows another device 290 according to the present invention comprising multiple cores (e.g., two cores 292, 294) including respective periphery separation lines 296, 298 having the same shape. The cores 292, 294 are overlaid during assembly to form the assembled display device resembling the assembled display device 170 of the embodiment shown in FIG. 6. A first core 292 of the cores includes separation lines forming a cutout 296 forming inner tabs 300 and the second core 294 includes separation lines forming slits 302 for receiving the inner tabs of the first core when the cores are overlaid during assembly. When the device 290 is assembled, designs 304 formed on the second core 304 are visible through the two cutout 296. Having two cores 292, 294 makes the assembled device thicker and thereby stronger and allows the maker and/or user to accent (e.g., color, texture, and/or add designs 304 to) the cores on the same side of the sheet. The device 290 according to this embodiment is otherwise the same as the embodiments described in the immediately preceding two paragraphs and therefore will not be described in further detail.

Assembling display devices according to the present invention may be accomplished as described above. For example, to assemble the display devices, the material of the sheet is separated along separation lines including outlines and folded along fold lines. Separation along the outlines separates the core from the surrounding material and may form tabs that are used for connecting parts of the device together and for standing. As described above, the separation lines may be perforated lines for controlled tearing or cutting along, ink lines for cutting along, or other. Separation is also performed along interior separation lines to form slits and cutouts. Cutouts may be viewed through when the device is assembled to view other parts of the device and/or items displayed with the device. Slits may be used to insert tabs through for connecting corresponding portions of the device for forming a three-dimensional structure and enabling the device to free stand (i.e., stand on its own).

As will be appreciated by those skilled in the art, the separations and folds made during assembly of each device according to the present invention may be made to accomplish various device attributes. For example, a user may adjust the amount to which a core of a device is folded to change a footprint (i.e., the portion of the device that contacts the supporting surface when the device is assembled and stood up) of the device to improve the stability of the device. As another example, the cutouts may be formed, folds made, and relative parts of a device connected to create various structural effects or visual effects, such as the shadow-box effect described herein. The device may also be attached to a surface for display. For example, any of the devices may be mounted on a wall by conventional ways such as by using tape or a thumb tack. A skilled artisan will be able to interpolate or extrapolate from the descriptions furnished if needed or desired to accomplish their design goals for forming the described display devices. That being said, the invention is designed so the various embodiments may be easily understood and used by the average consumer.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. A self-supporting display device having a three-dimensional shape when in an assembled state, the device comprising:
a single sheet including a core having a first end and a second end opposite the first end;
a surrounding material around the core; and
separation outlines separating the core from the surrounding material, thereby forming a periphery of the core when the sheet is separated along them during assembling of the device;
wherein the core includes:
a primary face having a display portion;
a first tab adjacent the first end of the core that supports the device when it is in the assembled state;
interior separation lines forming a cutout portion when the device is in an unassembled state; and
fold lines for folding along to form a three-dimensional shape during assembling of the device.

2. A display device as set forth in claim 1 wherein the core further includes a second tab adjacent the second end of the core, both tabs support the device when it is in the assembled state, and one of said fold lines is positioned at a base of each of the first and second tabs for bending the core about to angle the tabs with respect to the core.

3. A display device as set forth in claim 1 wherein said interior separation lines include a base separation line for forming a base structural slit adjacent the second end for receiving the first tab when the device is in the assembled state.

4. A display device as set forth in claim 1 wherein:
the core further includes a second tab adjacent the second end of the core;
both tabs support the device when it is in the assembled state;
one of said fold lines is positioned at a base of each of the first and second tabs for bending the core about to angle the tabs with respect to the core;
said interior separation lines include a base separation line for forming a base structural slit adjacent the second end for receiving the first tab when the device is in the assembled state; and
the second tab includes a slot on each of opposite edges of the tab for receiving securing portions of the core adjacent said base structural slit when the device is in the assembled state.

5. A display device as set forth in claim 1 wherein the core further includes a secondary face that is adjacent said primary face when the device is in the assembled state, said interior separation lines include multiple central separation lines on said secondary face for forming central slits for holding a display item, and said cutout portion is sized and shaped for viewing the display item through when the device is in the assembled state.

6. A display device as set forth in claim 4 wherein the display item comprises a photo.

7. A display device as set forth in claim 1 wherein the device is unitary when it is in the assembled state and the separation outlines and/or the interior separation lines are perforated.

8. A display device as set forth in claim 1 wherein the core further includes designs including at least one of a verbal message and colorful visual images.

9. A display device as set forth in claim 1 wherein the core further includes a second tab adjacent said second end of the core and a third tab connected directly to said first tab for supporting the device when it is in the assembled state.

10. A display device as set forth in claim 9 wherein said second tab includes a tab slit formed by one of said interior separation lines during assembling of the device and the first, second, and third tabs are configured so the third tab is inserted into said tab slit for supporting the device in the three-dimensional shape when the device is in the assembled state.

11. A display device as set forth in claim 1 wherein said cutout portion has corners and forms a clearance slit at each of said corners of the cutout and said fold lines include clearance fold lines, the clearance slits and the clearance fold lines being sized and shaped so clearance flaps are formed by separating the core at the clearance slits and folding the core about the clearance fold lines during assembling of the device.

12. A display device as set forth in claim 1 wherein said cutout forms a plurality of interior tabs.

13. A display device as set forth in claim 12 wherein the core further includes a secondary face that is adjacent said primary face when the device is in the assembled state, the interior separation lines include interior slit lines for forming interior slits during assembling of the device that are sized and located on the secondary face for receiving said interior tabs of the cutout when the device is in the assembled state.

14. A display device as set forth in claim 1 wherein:
said core is a first core and said sheet further includes a second core having a first end and a second end opposite the first end; and
said separation outlines separate the second core from said surrounding material, thereby forming a periphery of the second core when the sheet is separated along the separation outlines during assembling of the device.

15. A self-supporting display device as set forth in claim 14 wherein a shape of the periphery of the first core is substantially the same as a shape of the periphery of the second core.

16. A self-supporting display device having a three-dimensional shape when in an assembled state, the device comprising:
a core having a first end and a second end opposite the first end and a periphery surrounding the core, wherein the core includes:
a primary face having a display portion;
a first tab adjacent the first end of the core that supports the device when it is in the assembled state;
interior separation lines forming a cutout portion when the device is in an unassembled state; and
fold lines for folding along to form a three-dimensional shape during assembling of the device.

17. A method of creating a three-dimensional self-supporting display device comprising:
providing a generally rectangular blank having separation lines indicating where the blank is to be separated along and at least three fold lines indicating where the blank is to be folded;
separating adjacent portions of the blank separated by the separation lines from each other thereby forming a core including a tab for supporting the device; and
folding the blank along said at least three fold lines to form the three-dimensional display device, which can support itself in an upright position at least in part using said tab.

18. A method of creating a display device as set forth in claim 17 wherein the separating step further includes forming a slit sized and shaped for receiving at least a portion of said tab and the method further comprises inserting the tab through the slit to secure the blank to itself.

19. A method of creating a display device as set forth in claim 17 wherein the separating step further includes forming a cutout including a plurality of interior tabs and a plurality of corresponding interior slits and the method further comprises inserting each tab of the plurality of tabs into the corresponding interior slit to secure the blank to itself.

20. A method of creating a display device as set forth in claim 17 wherein the separating step further includes forming a plurality of item-holding slits for holding an item to be displayed using the device.
